(19) United States
(12) Patent Application Publication
(10) Pub. No.: US 2014/0188815 A1
(43) Pub. Date: Jul. 3, 2014

(54) Annotation of Resources in a Distributed Execution Environment

(71) Applicant: Amazon Technologies, Inc, (US)

(72) Inventors: Joshua Mentz, Cape Town (ZA); Ronen Dov Agranat, Cape Town (ZA); Timothy Ralph Sjoberg, Cape Town (ZA); Malcolm Featonby, Cape Town (ZA); Gregory Jonathan Kempe, Cape Town (ZA); Willem Jacob Buys, Cape Town (ZA)

(73) Assignee: Amazon Technologies, Inc, Seattle, WA (US)

(21) Appl. No.: 13/733,616

(22) Filed: Jan. 3, 2013

(51) Int. Cl. G06F 17/30

(52) U.S. Cl. CPC G06F 17/30085
USPC 707/689

(57) ABSTRACT

A distributed execution environment includes various resources, such as instances of computing resources, hardware resources, software resources, and others. A resource state viewing tool executing in conjunction with the distributed execution environment provides access to data regarding the state of each resource in the form of a resource page associated with the resource. The resource page for a resource might also include one or more annotations assigned to the resource by a user or by a component within the distributed execution environment. The annotations might have associated expiration data, such as an expiration time or event, which may be utilized to expire the annotations. The annotations might also have a namespace assigned thereto that is utilized when responding to requests to retrieve the annotations. The annotations might also have permissions assigned thereto that identify the rights of one or more users and/or components to read, modify, or delete the annotations.

### BACKGROUND

Network-based services exist that allow customers to purchase and utilize instances of computing resources (“instances”), such as virtual machine instances, on a permanent or as-needed basis. In addition to virtual machine instances, these services typically allow customers to purchase and utilize instances of other types of computing resources for use with the virtual machine instances. For example, customers might be permitted to purchase and utilize instances of data storage resources, instances of database resources, instances of networking resources, and instances of other types of resources. Utilizing instances of these various types, customers of such a service can create custom “solutions” that provide various types of functionality, such as application hosting, backup and storage, content delivery, World Wide Web (“Web”) hosting, enterprise information technology (“IT”) solutions, database services, and others.

Network-based services such as those described above might include large numbers of resources, such as the instances of computing resources described above and the hardware and software components utilized to provide the instances. Each of these resources might also have various types of information associated with it. For example, a resource might have associated information that describes any problems with the resource, steps taken to address the problems, software patches that have been or need to be applied to the resource, and potentially other types of data. Some types of resources might have a large quantity of associated information. As a result, it can sometimes be difficult for users to identify the most current and relevant information associated with these resources.

The disclosure made herein is presented with respect to these and other considerations.

### BRIEF DESCRIPTION OF THE DRAWINGS

FIG. 1 is a computer system diagram providing an overview description of one mechanism disclosed herein for annotating resources in a distributed execution environment, according to one embodiment presented herein;

FIG. 2 is a flow diagram showing aspects of one illustrative routine for creating a new annotation for a resource in a distributed execution environment, according to one embodiment disclosed herein;

FIG. 3 is flow diagram showing aspects of one illustrative routine disclosed herein for expiring annotations associated with resources in a distributed execution environment;

FIG. 4 is a computer system diagram showing aspects of one mechanism disclosed herein for retrieving an annotation for a resource in a distributed execution environment, according to one embodiment presented herein;

FIG. 5 is a flow diagram showing aspects of one illustrative routine for processing a request for an annotation associated with a resource in a distributed execution environment, according to one embodiment presented herein;

FIG. 6 is a flow diagram showing aspects of one illustrative routine for processing a request to modify or delete an annotation associated with a resource in a distributed execution environment, according to one embodiment presented herein;

FIG. 7 is a system and network diagram that shows one illustrative operating environment for the embodiments disclosed herein that includes a distributed execution environment;

FIG. 8 is a computing system diagram that illustrates one configuration for a data center that implements aspects of the concepts and technologies disclosed herein for annotating resources in a distributed execution environment, according to one embodiment disclosed herein; and

FIG. 9 is a computer architecture diagram showing one illustrative computer hardware architecture for implementing a computing device that might be utilized to implement aspects of the various embodiments presented herein.

### DETAILED DESCRIPTION

The following detailed description is directed to technologies for annotating resources in a distributed execution environment. Utilizing the concepts and technologies described herein, a user of a distributed execution environment can assign annotations to resources in the distributed execution environment. The annotations might provide textual or other types of information regarding the operational state of a resource, for example. The annotations might also have expiration data and/or a namespace assigned thereto. The expiration data can be utilized to “expire” annotations at a certain time or in response to the occurrence of a particular event. A namespace can be utilized to return only relevant annotations in response to requests to retrieve annotations for a resource. Through the use of these mechanisms, users and/or components within the distributed execution environment can be provided with only the most current and/or relevant annotations for a resource. Additional details regarding these and other features will be provided below.

According to one aspect presented herein, a computer-implemented mechanism is disclosed for annotating resources in a distributed execution environment. In one implementation, the mechanism operates in conjunction with a network-based distributed execution environment in which customers can purchase, configure, and utilize instances of computing resources, such as virtual machine instances, data storage resources, networking resources, and database resources, on a permanent or as-needed basis. The distributed execution environment may offer instances of computing resources for purchase and use in various configurations. For example, the distributed execution environment might offer virtual machine instances available for purchase and use that have many different configurations of processor capabilities, main memory, disk storage, and operating system. As mentioned above, a customer might create, configure, and deploy various combinations of instances of computing resources to create “solutions” that provide various types of functionality, such as application hosting, backup and storage, content delivery, Web hosting, enterprise IT solutions, database services, and others.

The distributed execution environment described above might include various types of resources including, but not limited to, instances of computing resources such as those described above, hardware resources such as server computers, software resources, resources describing customers and other users of the distributed execution environment, such as customer or user accounts, and other types of resources. As will be described in greater detail below, the technologies disclosed herein can be utilized to create and utilize annotations for these, and potentially other, types of resources in the distributed execution environment.

In order to facilitate annotation of resources in a distributed execution environment, a resource state viewing tool executes within or in conjunction with the distributed execution environment in one embodiment and provides a user interface (“UI”) through which users can view resource state data about a resource that is collected by a resource monitoring component or another component. For example, in one implementation the resource state viewing tool is configured to provide resource pages corresponding to resources in the distributed execution environment.

The resource pages might be utilized to view the resource state data for corresponding resources in the distributed execution environment. For example, a user might utilize a user computing system, like a desktop or laptop computer, to request and view a resource page for a particular server computer in the distributed execution environment. The resource page for the server computer provides the resource state data describing the operational state of the server computer. As discussed in greater detail below, the resource page might also include annotations for the resource created by users or components in the distributed execution environment. The resource page might also include a component for facilitating the creation of annotations for resources in the distributed execution environment.

As described briefly above, annotations are text and/or another type of data that is associated with a resource in the distributed execution environment. The annotations might be created by users of the distributed execution environment or by components within or external to the distributed execution environment. For example, a user of the distributed execution environment might create an annotation for a resource that specifies certain operational information about the resource, such as text indicating that the resource is malfunctioning for some reason.

Components within or external to the distributed execution environment might also create annotations for resources, such as annotations corresponding to a workflow related to the resource. As an example, a workflow component might create an annotation associated with a resource indicating that a particular step in a workflow has been performed with regard to the resource. Other types of annotations might also be created and associated with resources in the distributed execution environment.

In order to facilitate the creation of annotations, the resource state viewing tool, or another component, might expose one or more interfaces through which components can request that annotations be created for resources in the distributed execution environment. For example, the resource state viewing tool might generate and provide a resource page for a resource that includes an annotation component that a user can utilize to create an annotation for the resource. The user might then utilize the annotation component to create the annotation. In this regard, the user might utilize a UI provided by the annotation component to specify the annotation itself (i.e. the text or other content for the annotation). The annotation component then submits the annotation creation request to the resource state viewing tool. In response thereto, the resource state viewing tool creates a new annotation for the resource in an annotation data store or another suitable data store. The newly created annotation might then be presented to other users, made available to components for various uses, or utilized in other ways.

In some embodiments, a user or a component creating an annotation might also be permitted to specify expiration data for the annotation. The expiration data may be utilized to expire the annotation. For example, in one particular implementation the expiration data is an expiration time. In this implementation, the annotation is expired after the expiration time has passed. In another implementation, the expiration data is an expiration event. In this implementation, the annotation is expired after the specified event has occurred. For example, the expiration event might specify that an annotation be expired after a workflow component has performed a particular operation with regard to the resource. Other types of expiration events might also be specified.

In some embodiments, annotations are expired by deleting the annotations. In other embodiments, an expired annotation may not be deleted, but rather marked as expired. Annotations that have been marked as expired, rather than deleted, might still be presented to users with an indication that the annotations are expired. For example, such annotations might be displayed with strikethrough formatting or another type of formatting indicating to a user that the annotations have expired. Expired annotations might also be hidden until a user requests that the expired annotations be shown. In this way, a user can still view the expired annotations for a resource and utilize the potentially valuable information contained therein, but with an understanding that the annotations have expired.

In some implementations, a user or a component creating an annotation might also be permitted to specify a namespace associated with the annotation. By associating a namespace with each annotation, different types of annotations can be disambiguated from one another. For example, annotations created by users of the distributed execution environment might be assigned a namespace relating to operational issues. Annotations created by a workflow component might be assigned a namespace relating to a particular workflow. When a request to retrieve the annotations for a particular resource is processed, the returned results might be limited to a particular namespace. In this way, for example, only annotations relating to workflow can be returned to the workflow component. Similarly, only annotations relating to operational issues may be shown to users. It should be appreciated that these examples are merely illustrative and that other types of namespaces might be associated with annotations and utilized for other purposes.

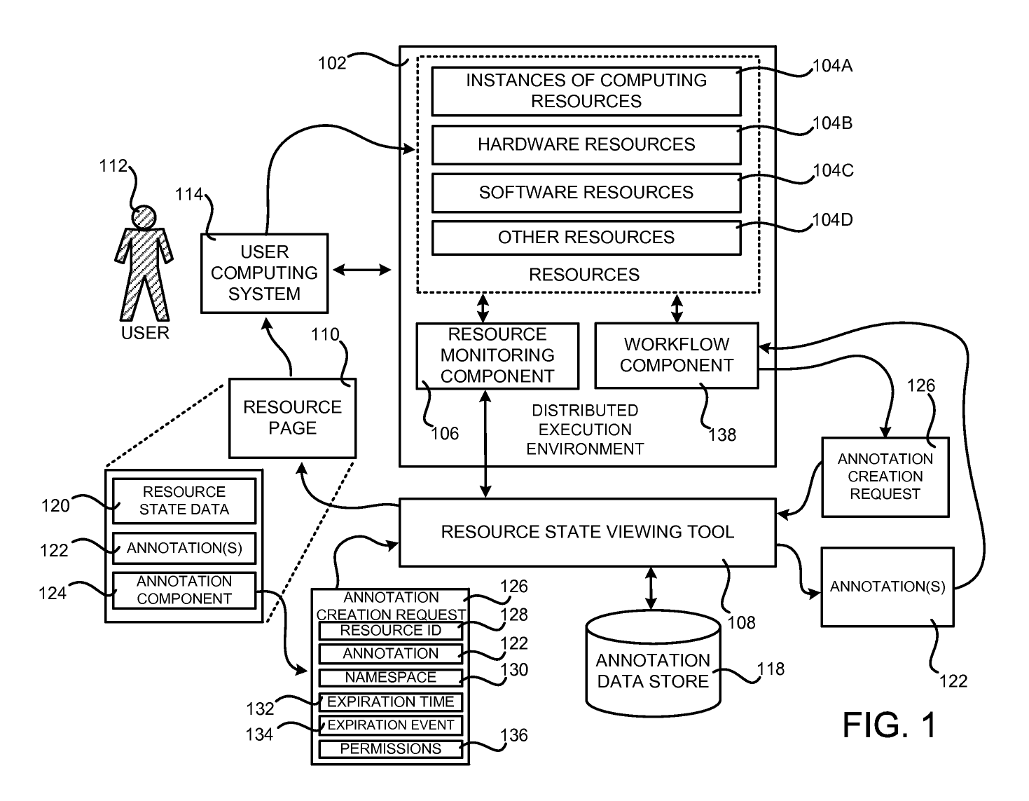

Permissions might also be specified for annotations associated with resources in a distributed execution environment. The permissions might identify the rights of users and/or components to read, modify, and/or delete the annotations and information associated with the annotations, such as the expiration data and the namespace for an annotation. Other types of information might also be associated with an annotation in other embodiments. Additional details regarding the various components and processes described above for annotating resources in a distributed execution environment will be presented below with regard to FIGS. 1-9.

It should be appreciated that the subject matter presented herein may be implemented as a computer process, a computer-controlled apparatus, a computing system, or an article of manufacture, such as a computer-readable storage medium. While the subject matter described herein is presented in the general context of program modules that execute on one or more computing devices, those skilled in the art will recognize that other implementations may be performed in combination with other types of program modules. Generally, program modules include routines, programs, components, data structures, and other types of structures that perform particular tasks or implement particular abstract data types.

Those skilled in the art will also appreciate that aspects of the subject matter described herein may be practiced on or in conjunction with other computer system configurations beyond those described herein, including multiprocessor systems, microprocessor-based or programmable consumer electronics, minicomputers, mainframe computers, handheld computers, personal digital assistants, e-readers, cellular telephone devices, special-purposed hardware devices, network appliances, and the like. The embodiments described herein may be practiced in distributed execution environments, where tasks are performed by remote processing devices that are linked through a communications network. In a distributed execution environment, program modules may be located in both local and remote memory storage devices.

In the following detailed description, references are made to the accompanying drawings that form a part hereof, and that show, by way of illustration, specific embodiments or examples. The drawings herein are not drawn to scale. Like numerals represent like elements throughout the several figures (which may be referred to herein as a “FIG.” or “FIGS.”).

FIG. 1 is a computer system diagram providing an overview description of a mechanism disclosed herein for annotating resources in a distributed execution environment 102, according to one embodiment presented herein. In one embodiment, the mechanism disclosed herein operates in conjunction with a network-based distributed execution environment 102 in which customers can purchase and utilize instances of computing resources 104A, such as virtual machine instances, on a permanent or as-needed basis. The distributed execution environment 102 may offer instances of computing resources 104A for purchase in various configurations. For example, the distributed execution environment 102 might offer virtual machine instances available for purchase and use that have many different configurations of processor capabilities, main memory, disk storage, and operating system.

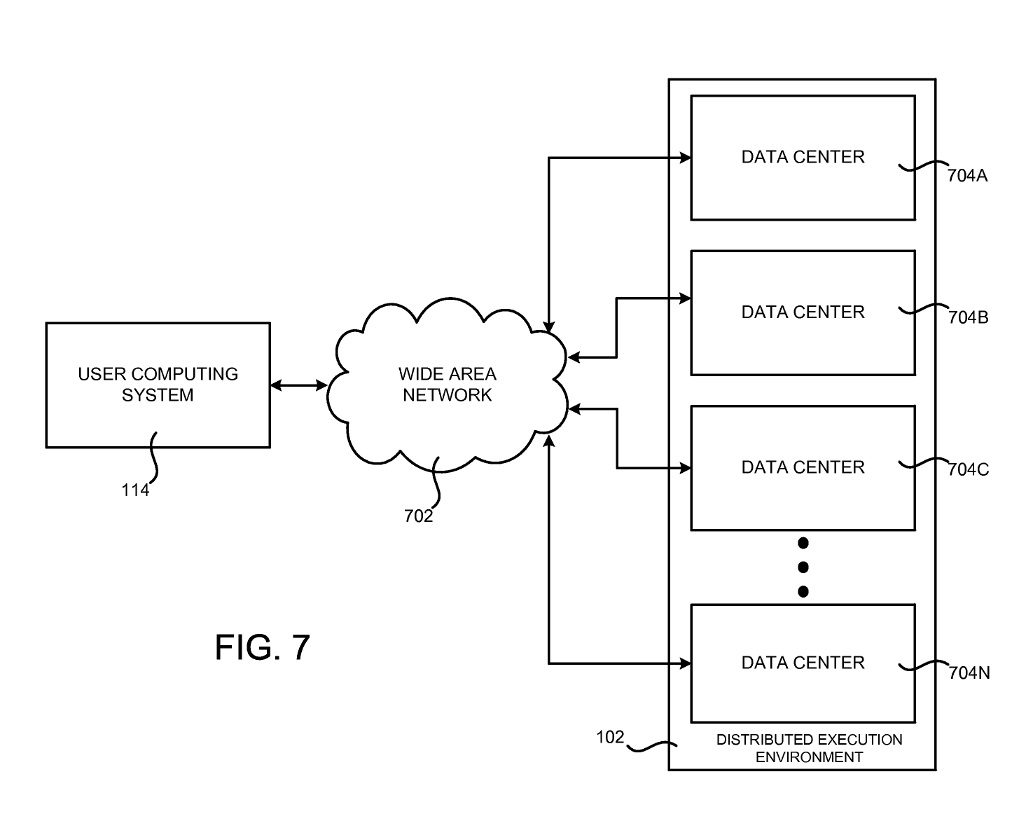

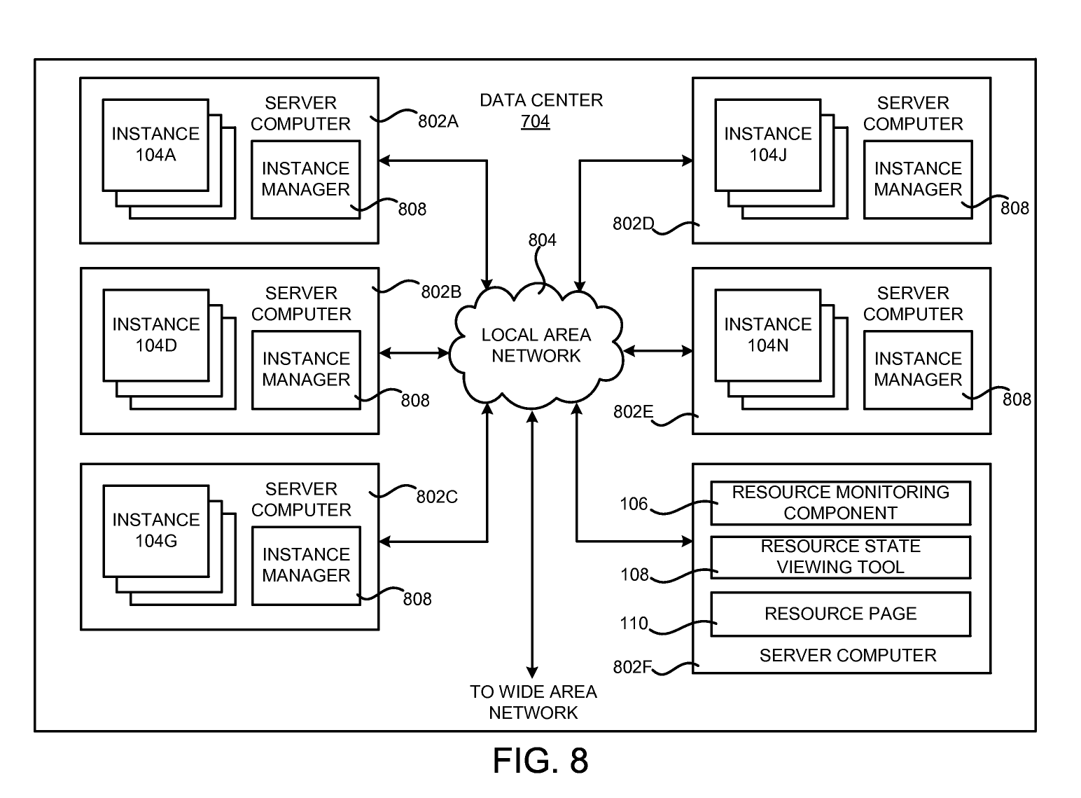

The distributed execution environment 102 might also offer instances of computing resources 104A for purchase and use by customers other than virtual machine instances. For example, the distributed execution environment 102 might offer data storage resources, networking resources, database resources, and other types of resources on a permanent or as needed basis. The operator of the distributed execution environment 102 may charge a fee for operating the instances to the customer that creates the instances. Various different pricing models might be utilized to charge a customer for use of instances of computing resources 104A within the distributed execution environment 102. Details regarding the configuration and operation of the distributed execution environment 102 will be provided below with regard to FIGS. 7 and 8.

In addition to the instances of computing resources 104A described above, the distributed execution environment 102 might also include many other types of resources. For example, and without limitation, the distributed execution environment 102 might also include hardware resources 104B such as server computers, software resources 104C, and other resources 104D, such as resources describing customers and other users of the distributed execution environment 102. The hardware resources 104B and the software resources 104C might be utilized to provide the instances of computing resources 104A or for other purposes. The distributed execution environment 102 might also include other types of resources 104 not shown in FIG. 1 or identified explicitly above. As will be described in greater detail below, the technologies disclosed herein can be utilized to create and view annotations associated with these, and potentially other, types of resources 104 in the distributed execution environment 102.

In some implementations, a resource monitoring component 106 executes within or in conjunction with the distributed execution environment 102 and collects data regarding the state of the resources 104 in the distributed execution environment 102. For example, the resource monitoring component 106 might collect resource state data 120 that describes the operational state of hardware resources 104B, like server computers, in the distributed execution environment 102. The resource monitoring component 106 might similarly collect resource state data 120 that describes the operational state of instances of computing resources 104A, such as virtual machine instances. The resource monitoring component 106 might also collect resource state data 120 for other types of resources, such as information about customers of the distributed execution environment 102.

In some implementations, the resource monitoring component 106 also makes the collected resource state data 120 available for consumption and use by other components. For example, in some embodiments, the resource monitoring component 106 is configured to expose an API through which other components can request and receive the resource state data 120 for a particular resource 104. It should be appreciated that while the resource state data 120 is discussed herein primarily in the context of data describing the operational state of a resource 104, the resource state data 120 might include other information about a resource 104. In this way, the resource monitoring component 106 can be utilized to obtain virtually any type of information about a resource 104 in the distributed execution environment 102.

In some embodiments, a resource state viewing tool 108 also executes within or in conjunction with the distributed execution environment 102 and provides a UI through which users 112 can view the resource state data 120 collected by the resource monitoring component 106. For example, in one implementation the resource state viewing tool 108 is configured to provide resource pages 110 corresponding to resources 104 in the distributed execution environment 102. The resource pages 110 might be utilized to view the resource state data 120 for corresponding resources 104 in the distributed execution environment 102. For example, a user 112 might utilize an appropriate client application (not shown in FIG. 1) executing on a user computing system 114, like a desktop or laptop computer, to request and view a resource page 110 for a particular server computer in the distributed execution environment 102. The resource page 110 for the server computer provides the resource state data 120 describing the operational state of the server computer and, as mentioned above, potentially other information.

In one embodiment, each resource page 110 corresponds to a resource 104 in the distributed execution environment 102. For example, in one particular implementation, a unique uniform resource locator (“URL”) is associated with each resource page 110. The URL might include a unique identifier for the resource 104 that corresponds to the associated resource 104 in the distributed execution environment 102. In this way, users 112 of the distributed execution environment 102 can utilize a unique URL to access the resource page 110 for the associated resource 104. In this implementation, a World Wide Web (“Web”) browser application (not shown in FIG. 1) executing on a user computing system 114 might be utilized to retrieve and render each resource page 110. It should be appreciated, however, that different mechanisms might be utilized to generate and provide the resource pages 110, and different types of client applications might also be utilized in other embodiments to receive and render the resource pages 110.

As shown in FIG. 1, the resource page 110 might also include one or more annotations associated with the resource 104 corresponding to the resource page 110. As mentioned above, the annotations 122 are text or other types of data associated with a resource 104. For example, the user 112 might utilize the mechanisms disclosed herein to associate text, images, audio, video, or other types of data with a particular resource 104 in the distributed execution environment 102. Components operating within or external to the distributed execution environment 102 might also utilize the various mechanisms disclosed herein to create and utilize annotations 122. For instance, in the example shown in FIG. 1, a workflow component 138 is creating and utilizing annotations 122. The workflow component 138 is a component that manages workflows performed with regard to the resources 104, such as workflows for deploying software, performing maintenance on the resources 104, or performing other tasks. Additional details regarding the various processes disclosed herein for creating and utilizing annotations 122 will be provided below.

In order to permit a user 112 to create annotations 122, the resource page 110 includes an annotation component 124 in one embodiment. The annotation component 124 provides a suitable UI through which the user 112 can specify an annotation 122. The UI provided by the annotation component 124 might also allow the user to specify other types of information associated with the annotation 122, such as expiration data, a namespace, and permissions. Additional details regarding this data will be provided below.

When the user 112 is ready to submit an annotation 122 to the resource state viewing tool 108, the user might select an appropriate user interface provided by the annotation component 124. In response thereto, the annotation component 124 transmits an annotation creation request 126 to the resource state viewing tool 108 that includes a resource identifier 128 for the resource, the annotation 122, and potentially additional information provided by the user 112. The annotation creation request 126 might be provided to the resource state viewing tool 108 by way of a Web service API or another suitable mechanism.

In response to receiving the annotation creation request 126, the resource state viewing tool 108 stores the annotation 122 and the associated data in an annotation data store 118. In one embodiment, the annotation data store 118 is a MySQL database configured for storing the annotations 122. It should be appreciated, however, that other suitable database technologies might also be utilized for storing and accessing the annotations 122 in the manner described herein.

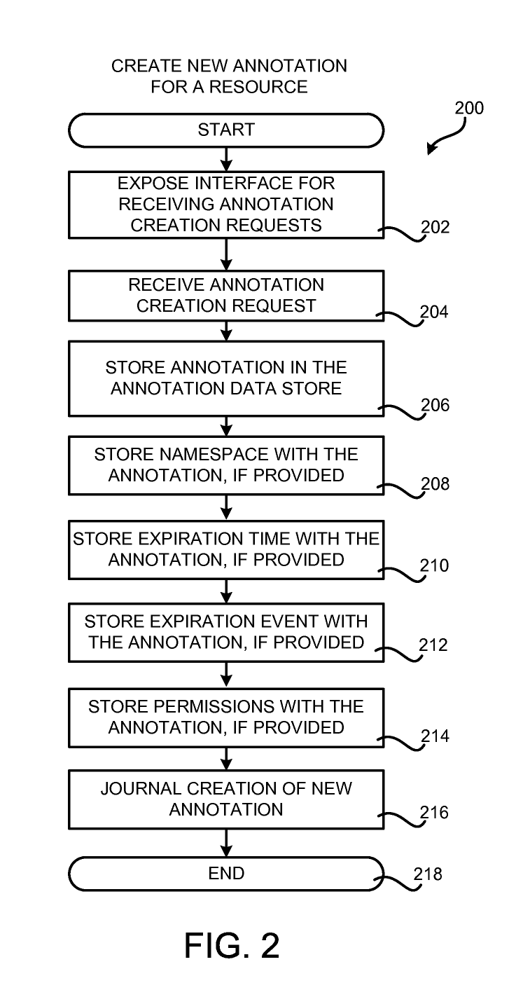

As mentioned briefly above, the annotations 122 for a resource 104 might be presented to a user 112 on a resource page 110 for the resource 104. Additionally, software and hardware components within or external to the distributed execution environment 102 might also create and utilize annotations 122 in a similar fashion. In the example shown in FIG. 1, for instance, a workflow component 138 can submit an annotation creation request 126 to the resource state viewing tool 108 to create an annotation for a resource 104. The workflow component 138 might also request and receive annotations 122 from the resource state viewing tool 108 by way of a suitable API or other mechanism. As will be described in greater detail below, a namespace 130 might also be associated with each annotation 122 so that only annotations 122 of interest can be returned to interested parties. Additional details regarding the creation of a new annotation 122 for a resource 104 in the distributed execution environment 102 will be provided below with regard to FIG. 2.

As discussed briefly above, an annotation creation request 126 received either from a user 112 or from a component might include information in addition to the resource identifier 128 and the annotation 122. In particular, in one implementation, the annotation creation request 126 also includes expiration data for the annotation 122. For example, in one particular implementation the expiration data is an expiration time 132, which might specify a date and/or time at which the associated annotation 122 is to expire. In this implementation, the annotation 122 is considered to have expired after the expiration time 132 has passed.

In another implementation, the expiration data is an expiration event 134. In this implementation, the annotation 122 is considered to have expired after the specified expiration event 134 has occurred. For example, the expiration event 134 might specify that the annotation 122 be considered to have expired after the workflow component 138 has performed a particular operation with regard to the associated resource 104. A user 112 or component might also specify other types of expiration events 134.

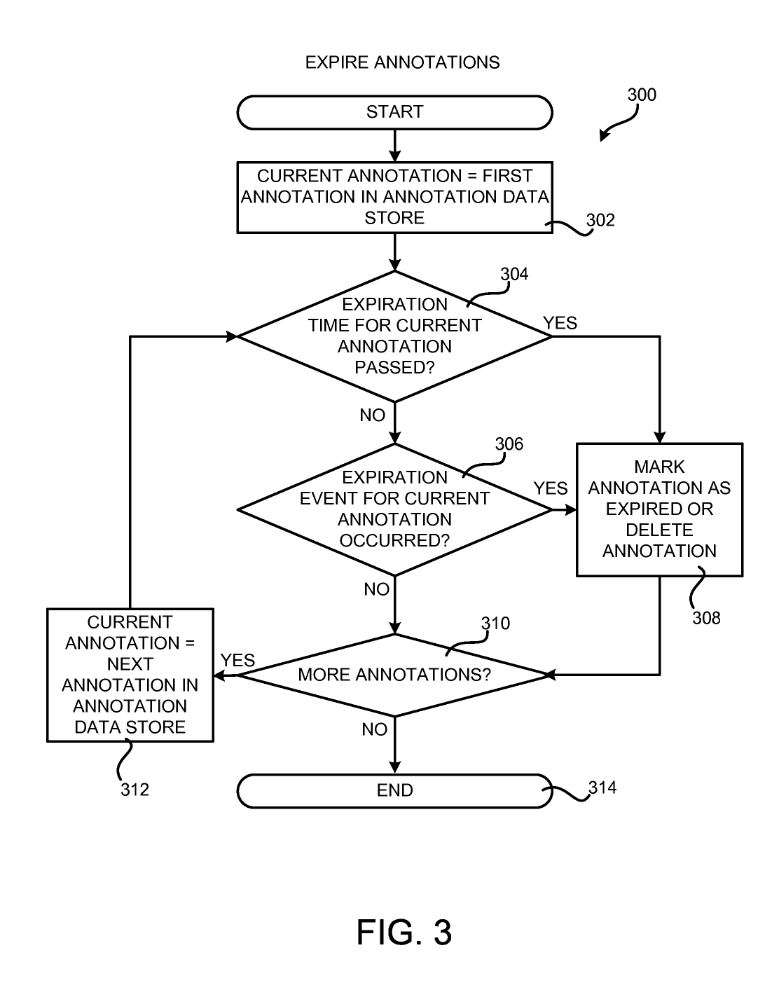

In some embodiments, annotations 122 are expired by deleting the annotations 122. In other embodiments, an expired annotation 122 may not be deleted, but rather marked as expired. Annotations 122 that have been marked as expired, rather than deleted, might still be presented to users 112 with an indication that the annotations 122 are expired. For example, such annotations 122 might be displayed with strikethrough formatting or another type of formatting indicating to a user 112 that the annotations 122 have expired. Expired annotations might also be hidden until a user requests that the expired annotations be shown. In this way, a user 112 can still view the expired annotations 122 for a resource 104 and utilize the potentially valuable information contained therein, but with an understanding that the annotations 122 have expired. Additional details regarding one process for expiring annotations will be provided below with regard to FIG. 3.

As mentioned briefly above, a user 122 or a software or hardware component creating an annotation 122 might also be permitted to specify a namespace 130 associated with the annotation 122. By associating a namespace 130 with each annotation 122, different types of annotations 122 can be disambiguated from one another. For example, annotations 122 created by users 112 of the distributed execution environment 102 might be assigned a namespace 130 relating to operational issues. Annotations 122 created by the workflow component 138 might be assigned a different namespace that relates to a particular workflow.

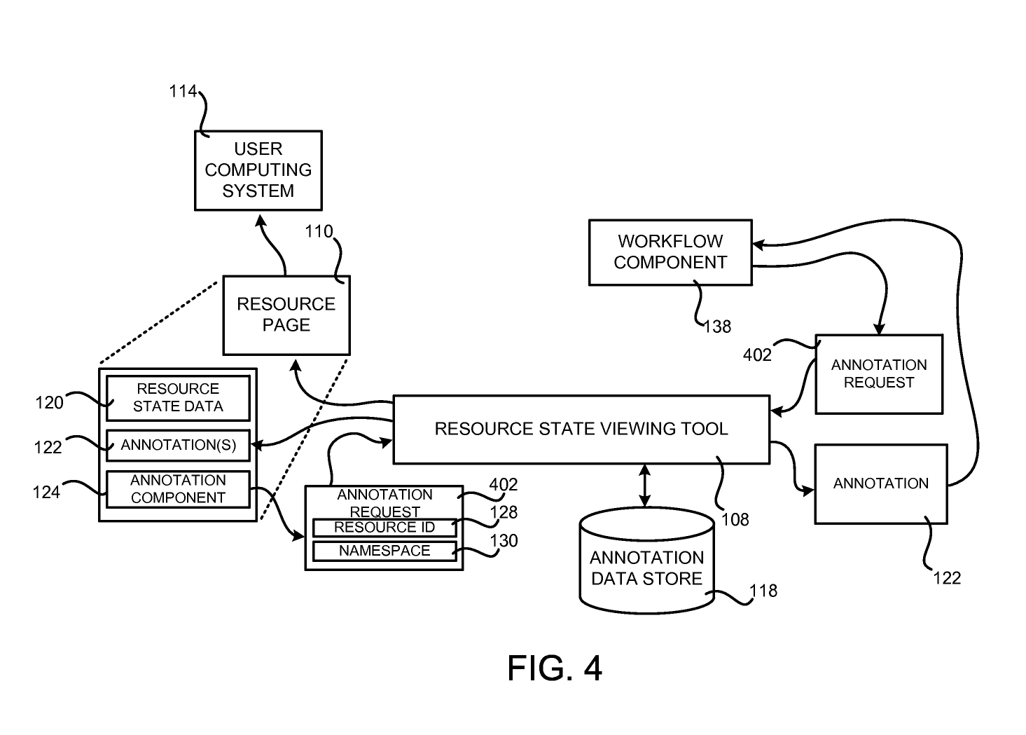

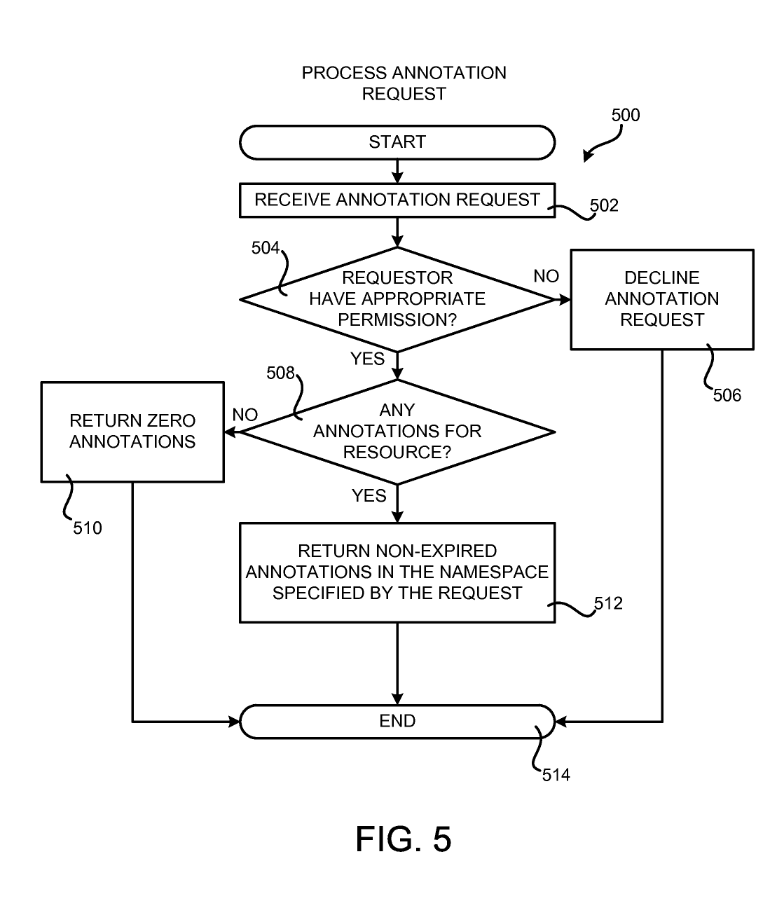

When the resource state viewing tool 108, or another component, processes a request to retrieve the annotations 122 for a particular resource 104, the returned annotations 122 might be limited to a particular namespace 130. In this way, for example, only annotations 122 relating to workflow can be returned to the workflow component 138. Similarly, only annotations 122 relating to operational issues may be shown to users 112 by way of a resource page 110 or other UI. It should be appreciated that these examples are merely illustrative and that other types of namespaces 130 might be associated with annotations 122 and utilized for other purposes. Additional details regarding the use of a namespace 130 to process a request to retrieve annotations 122 will be provided below with regard to FIGS. 4 and 5.

As also mentioned briefly above, an annotation creation request 126 might also specify one or more permissions 136 for the annotations 122. The permissions 136 might identify the rights of users 112 and/or components to read, modify, and/or delete the annotations 122 and/or information associated with the annotations 122, such as the expiration data and/or the namespace 130 for an annotation 122. Other types of information might also be associated with an annotation 122 in other embodiments. Additional details regarding the use of the permissions 136 to process requests to read, modify, and/or delete annotations 122 and their associated information will be provided with regard to FIGS. 4-6.

It should be appreciated that the users 112 of the distributed execution environment 102 might be users employed by the owner or operator of the distributed execution environment 102. In this case, the users 122 might be permitted to view resource pages 110 in an unlimited fashion. The users 112 might also be limited to certain resource pages 110 based upon a security or clearance level or some other mechanism. In other embodiments, however, the users 112 might be customers of the distributed execution environment 102 or employees of the customers. In this case, the users 112 might be limited to viewing resource pages 110 for resources 104 in the distributed execution environment 102 that have been purchased by the customer. In this way, customers can only view resource pages 110 for their own resources 104. The provision of resource pages 110 to users 112 of the distributed execution environment 102 might also be limited in other ways.

It should also be appreciated that the contents of the resource page 110 shown in FIG. 1 are merely illustrative and that the resource page 110 might include some or all of the items shown in FIG. 1. The resource page 110 shown in FIG. 1 might also include other software components not shown in FIG. 1. Many more computers, networking devices, networks, software components, and other devices might be utilized in order to provide the functionality described herein. Moreover, these devices might be arranged, configured, and interconnected in other ways than shown in FIG. 1 to achieve the technical result disclosed herein. The embodiments presented herein should not be limited to the particular arrangement shown in FIG. 1 or the other FIGS.

FIG. 2 is a flow diagram showing aspects of one illustrative routine 200 for creating a new annotation 122 for a resource 104 in a distributed execution environment 102, according to one embodiment disclosed herein. It should be appreciated that the logical operations described herein with respect to FIG. 2 and the other figures are implemented (1) as a sequence of computer implemented acts or program modules running on a computing system and/or (2) as interconnected machine logic circuits or circuit modules within the computing system. The implementation of the various components described herein is a matter of choice dependent on the performance and other requirements of the computing system. Accordingly, the logical operations described herein are referred to variously as operations, structural devices, acts, or modules. These operations, structural devices, acts, and modules may be implemented in software, in firmware, in special purpose digital logic, and any combination thereof. It should also be appreciated that more or fewer operations may be performed than shown in the FIGS. and described herein. These operations may also be performed in parallel, or in a different order than those described herein.

The routine 200 begins at operation 202, where the resource state viewing tool 108, or another component executing within or external to the distributed execution environment 102, exposes an interface for receiving annotation creation requests 126. As mentioned above, the interface might be a Web service API or another type of interface suitable for receiving annotation creation requests 126 from an annotation component 124, from a workflow component 138, or from another type of component. In some embodiments, the components might also store annotations 122 and any associated information directly in the annotation data store 118. Other implementations might also be utilized.

From operation 202, the routine 200 proceeds to operation 204, where the resource state viewing tool 108 receives an annotation creation request 126. In the example shown in FIG. 1, for instance, the resource state viewing tool 108 is receiving an annotation creation request 126 from the annotation component 124 in the resource page 110. As also shown in FIG. 1 and described above, the annotation creation request 126 includes the annotation 122 and a resource identifier 128 for the resource 104 for which the annotation 122 should be created. The resource identifier 128 might be a globally unique identifier (“GUID”), an Internet Protocol (“IP”) address, an asset number, or another type of indicator that uniquely identifies the resource 104 for which the new annotation 122 should be created.

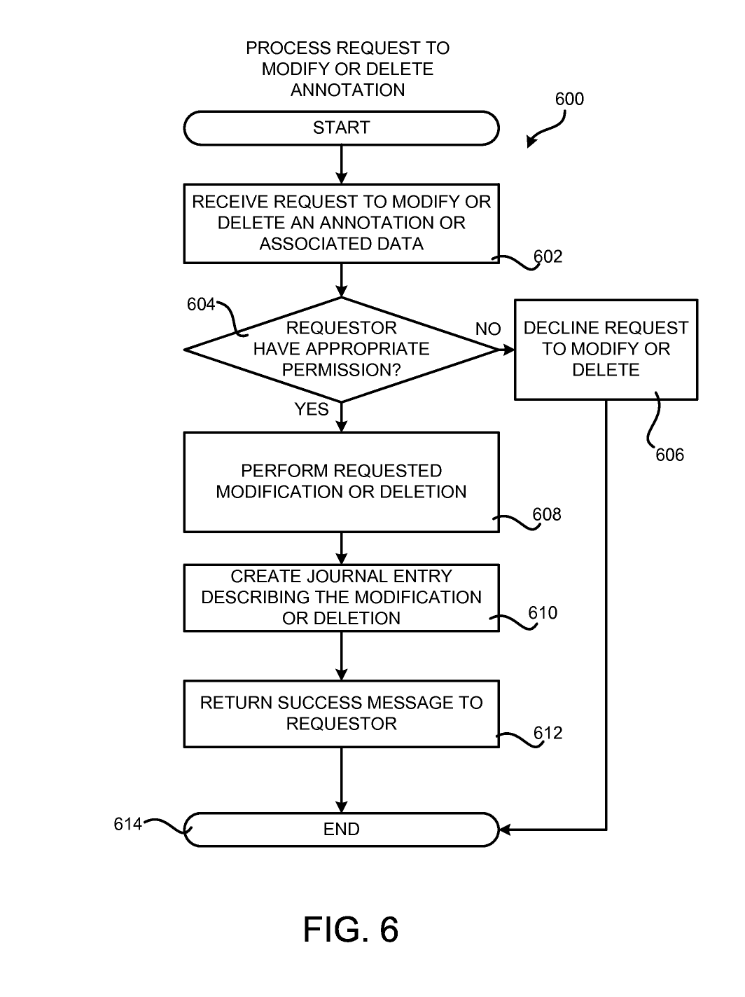

From operation 204, the routine 200 proceeds to operation 206, where the resource state viewing tool 108 stores the annotation 122 received in the annotation creation request 126 in the annotation data store 118. Additionally, data might be stored that identifies the user, component, or system that submitted the annotation creation request 126. The routine 200 then proceeds to operation 208, where the resource state viewing tool 108 stores a namespace 130 associated with the annotation 122 in the annotation data store 118 if a namespace 130 is provided in the annotation creation request 126. As mentioned briefly above, and as will be described in greater detail below with regard to FIGS. 5 and 6, the namespace 130 may be utilized to disambiguate different types of annotations 122 from one another.

From operation 208, the routine 200 proceeds to operations 210 and 212, where any expiration data provided in the annotation creation request 126 is also stored in the annotation data store 118. For example, at operation 210, an expiration time 132 for the new annotation 122 may be stored in the annotation data store 118, if provided in the annotation creation request 126. Similarly, at operation 212, an expiration event 134 for the new annotation 122 may be stored in the annotation data store 118, if specified in the annotation creation request 126. Details regarding the use of the expiration data to expire the new annotation 122 will be provided below with regard to FIG. 3.

From operation 212, the routine 200 proceeds to operation 214, where permissions 136 described in the annotation creation request 126 are also stored in the annotation data store 118. Additional details regarding the use of the permissions 136 for an annotation 122, if provided, to restrict access to and modification of the annotation 122 will be described below with regard to FIGS. 5 and 6.

From operation 214, the routine 200 proceeds to operation 216, where data describing the creation of a new annotation 122 in the annotation data store 118 might be stored in a log or journal in some embodiments. As will be described below with regard to FIG. 6, modification or deletion of an annotation 122 and/or its associated information might also be journaled in a similar manner. In this way, a complete record can be kept regarding the changes to an annotation 122 throughout its lifespan. This information might be made available to a user 112 of the distributed execution environment 102 and/or to components for use in various ways. From operation 216, the routine 200 proceeds to operation 218, where it ends.

FIG. 3 is flow diagram showing aspects of one illustrative routine 300 disclosed herein for expiring annotations 122 associated with resources 104 in a distributed execution environment 102. As discussed above, the expiration data associated with annotations 122 might be utilized to delete the annotations or mark the annotations as having expired. In the embodiment shown in FIG. 3, for example, the resource state viewing tool 108, or another component, periodically executes a process that examines the expiration data for each annotation 122 to determine if the annotation 122 has expired. In other embodiments, however, events might be generated based upon the supplied expiration data in order to trigger the expiration of the annotations 122. Other implementations might also be utilized to evaluate the expiration data to determine whether an annotation 122 has expired and, if so, to delete or otherwise mark the annotation 122 as expired.

The routine 300 begins at operation 302, where a variable for storing data describing the current annotation 122 being processed is initialized to store data identifying the first annotation 122 in the annotation data store 118. For example, the resource identifier 128 for the first annotation 122 in the annotation data store 118 might be stored in the variable at operation 302.

From operation 302, the routine 300 proceeds to operation 304, where a determination is made as to whether the expiration time 132 for the current annotation 122 has passed. If the expiration time 132 has passed, the routine 300 proceeds from operation 304 to operation 308, where the current annotation 122 is deleted or marked as expired. From operation 308, the routine 300 proceeds to operation 310, described below.

If, at operation 304, it is determined that the expiration time 132 for the current annotation 122 has not passed, the routine 300 proceeds from operation 304 to operation 306. At operation 306, a determination is made as to whether the expiration event 134 specified for the current annotation 122 has occurred. If the specified event has occurred, the routine 300 proceeds from operation 306 to operation 308, where the current annotation 122 is deleted or marked as expired. From operation 308, the routine 300 proceeds to operation 310, described below.

If, at operation 306, it is determined that the expiration event 134 for the current annotation 122 has not occurred, the routine 300 proceeds from operation 306 to operation 310. At operation 310, a determination is made as to whether there are any additional annotations 122 in the annotation data store 118 that remain to be processed. If so, the routine 300 proceeds from operation 310 to operation 312, where the variable storing the current annotation 122 being processed is incremented to the next annotation 122 in the data store 118. The routine 300 then proceeds from operation 312 to operation 304, where the next annotation 122 is processed in the manner described above. If no additional annotations 122 remain to be processed, the routine 300 proceeds from operation 310 to operation 314, where it ends.

As mentioned briefly above, the routine 300 shown in FIG. 3 might be performed periodically to expire annotations 122 stored in the annotation data store 118. For example, this process might be performed every 15 minutes or other time period in order to ensure that expired annotations 122 are frequently deleted or marked as expired. As also mentioned above, other event-based mechanisms might also be utilized to expire the annotations 122 at or near the expiration time 132 or the time at which an expiration event 134 occurs. Other mechanisms might also be utilized.

FIG. 4 is a computer system diagram showing aspects of one mechanism disclosed herein for retrieving an annotation 122 for a resource 104 in a distributed execution environment 102, according to one embodiment presented herein. As shown in FIG. 4 and described briefly above, various components may request the annotations 122 for a resource 104 from the resource state viewing tool 108, or other component configured to maintain the annotation data store 118 and respond to requests for the annotations 122 contained therein.

For instance, in the example shown in FIG. 4, the annotation component 124 in the resource page 110 has transmitted an annotation request 402 to the resource state viewing tool 108. The annotation component 124 may display the annotations 122 returned in response to the request 402, if any, in the resource page 110 presented to the user 112 by way of the user computing system 114. Other components, such as the workflow component 138, might also submit an annotation request 402 to the resource state viewing tool 108.

As also shown in FIG. 4, the annotation request 402 includes the resource identifier 128 for the resource 104 for which annotations 122 should be returned. In some embodiments, the annotation request 402 also includes a namespace 130. As will be described in greater detail below, the namespace 130 provided with the annotation request 402 might be utilized to filter the annotations 122 that are returned in response to the request 402. In particular, the returned annotations 122 might be restricted to those annotations 122 associated with the resource identifier 128 in the request 402, and that have the same namespace 130 as the namespace in the request 402. Additional details regarding this process are provided below with regard to FIG. 5.

In order to provide the functionality described above, the resource state viewing tool 108, or another component configured to manage the annotation data store 118, might expose an appropriate interface for receiving and responding to annotation requests 402. For example, the resource state viewing tool 108 might expose a Web service API for receiving and responding to annotation requests 402. In other embodiments, authorized components might retrieve annotations 122 directly from the annotation data store 118. Other configurations might also be utilized.

FIG. 5 is a flow diagram showing aspects of one illustrative routine 500 for processing a request 402 for the annotations 122 associated with a resource 104 in a distributed execution environment 102, according to one embodiment presented herein. The routine 500 begins at operation 502, where the resource state viewing tool 108, or another component configured to process annotation requests 402, receives an annotation request 402. As mentioned above with regard to FIG. 4, the annotation request 402 might include a resource identifier 128 and a namespace 130.

In response to receiving an annotation request 402, the routine 500 proceeds to operation 504, where a determination is made as to whether the component making the annotation request 402 has permission to retrieve the annotations 122 for the identified resource 104. As mentioned above, permissions 136 might be specified at the time an annotation 122 is created that define the ability for components to read, modify, and/or delete the annotation 122. The permissions 136 might also be specified and/or modified at a time other than the time at which an annotation 122 is created.

If the permissions 136 indicate that the component that submitted the annotation request 402 does not have permission to read the annotations 122 for the identified resource 104, the routine 500 proceeds from operation 504 to operation 506. At operation 506, a response is returned to the annotation request 402 indicating that the annotation request 402 has been declined. The routine 500 then proceeds from operation 506 to operation 514, where it ends.

If, however, the component that submitted the annotation request 402 does have appropriate permission to retrieve the annotations 122, the routine 500 proceeds from operation 504 to operation 508. At operation 508, a determination is made as to whether any annotations 122 exist for the resource 104 identified by the resource identifier 128 specified in the annotation request 402. If no annotations 122 exist for the identified resource 104, the routine 500 proceeds from operation 508 to operation 510, where an indication is returned in response to the request 402 indicating that no annotations are available. The routine 500 then proceeds from operation 510 to operation 514, where it ends.

If, however, it is determined at operation 508 that annotations 122 do exist for the resource 104 identified by the resource identifier 128 specified in the annotation request 402, the routine 500 proceeds from operation 508 to operation 512. At operation 512, any non-expired annotations 122 associated with the resource identifier 128 that also have the same namespace 130 as specified in the annotation request 402 are returned. In other embodiments, expired annotations 122 might also be returned with an indication that the annotations have expired 122. By using the namespace 130 in this manner, the returned annotations 122 can be filtered to a particular type of annotation 122. For instance, and as described above, annotations 122 relating to operational issues with a resource 104 might be assigned a certain namespace 130 and returned in response to a request from the annotation component 124. Similarly, annotations 122 relating to workflow might be assigned a different namespace 130 and returned in response to a request from the workflow component 138. Other namespaces 130 might also be assigned and returned in response to requests from other components. From operation 512, the routine 500 proceeds to operation 514, where it ends.

FIG. 6 is a flow diagram showing aspects of one illustrative routine 600 for processing a request to modify or delete an annotation 122 associated with a resource 104 in a distributed execution environment 102, according to one embodiment presented herein. In order to provide the functionality shown in FIG. 6, the resource state viewing tool 108, or another component, might provide a suitable interface through which other components can submit requests to modify and/or delete annotations 122 and their associated data, such as a namespace 130, expiration data, and/or permissions 136. For example, a Web service API or another type of API might be exposed through which components can submit such deletion and/or modification requests. FIG. 6 illustrates the processing of these requests according to one embodiment disclosed herein.

The routine 600 begins at operation 602, where a request is received to delete or modify an annotation 122 or the data associated with an annotation 122 described above. In response to receiving such a request, the routine 600 proceeds from operation 602 to operation 604, where a determination is made as to whether the component making the request has permission to perform the requested modification or deletion. The permissions 136 for the annotation 122 to be modified or deleted may be utilized to make this determination in one embodiment.

If the permissions 136 indicate that the component that submitted the deletion or modification request does not have permission to perform the requested operation, the routine 600 proceeds from operation 604 to operation 606. At operation 606, a response is returned to the deletion or modification request indicating that the request has been declined. The routine 600 then proceeds from operation 606 to operation 614, where it ends.

If, however, it is determined at operation 604 that the requesting component does have the required permission to perform the requested modification or deletion, the routine 600 proceeds from operation 604 to operation 608. At operation 608, the requested modification or deletion of the annotation 122 is performed. The routine 600 then proceeds to operation 610, where data describing the performed operation is stored in a log or journal in the manner described above. In this way, data is recorded describing the modification and deletion of annotations 122 and their associated data. As mentioned above, a user 112 or a component might utilize this information for various purposes.

From operation 610, the routine 600 proceeds to operation 612, where a success message is returned to the component that requested the deletion or modification. The success message indicates that the requested operation was performed successfully. From operation 612, the routine 600 proceeds to operation 614, where it ends.

It should be appreciated that various scenarios might be enabled utilizing the functionality described above. For instance, users 112 of the distributed execution environment 102 might define annotations 122 for host computers utilized to provide instances of computing resources 104 that relate to the operational status of the computers. As a particular example, the users 112 might define annotations 122 indicating that a host computer utilized to provide virtual machine instances is malfunctioning and define information that describes the troubleshooting of the host computer.

The annotations 122 described above might also be utilized to track host computers involved in a large scale service outage. Resources 104 might also be tagged with annotations 122 indicating their manufacturer, vendor, software or hardware revision number, and potentially other similar information. In other embodiments, functionality might also be provided for searching the annotations 122. For example, all host computers having a certain associated annotation 122 and/or namespace 130 might be identified through such a search. Expired annotations that have not been deleted may be searchable in some embodiments.

As mentioned above, certain components might also define annotations 122 for a resource 104 that relate to a particular workflow being performed with respect to the resource 104. As one specific example, the workflow component 138 might detect a failed or malfunctioning host computer in the distributed execution environment 102. In response thereto, the workflow component 138 might create an annotation 122 associated with the host computer that indicates that the host computer needs to be repaired.

The workflow component 138, or another component, might also search for host computers having an associated annotation 122 indicating that repair is needed. The workflow component 138 could then associate different annotations 122 with the host computers at different times during the repair workflow. Once the repair has been completed, the workflow component 138 might expire the workflow annotations 122 in the manner described above. It should be appreciated that these example scenarios are merely illustrative and that other scenarios might be enabled through the use of the concepts and technologies described above.

FIG. 7 and the following description are intended to provide a brief, general description of a suitable computing environment in which the embodiments described herein may be implemented. In particular, FIG. 7 is a system and network diagram that shows an illustrative operating environment that includes a distributed execution environment 102. As discussed above, the distributed execution environment 102 can provide instances of computing resources 104A on a permanent or an as-needed basis.

The instances of computing resources provided by the distributed execution environment 102 may include various types of resources, such as data processing resources, data storage resources, networking resources, data communication resources, and the like. Each type of computing resource may be general-purpose or may be available in a number of specific configurations. For example, and as will be described in greater detail below, instances of data processing resources may be available as virtual machine instances in a number of different configurations. The virtual machine instances may be configured to execute applications, including Web servers, application servers, media servers, database servers, and other types of applications. Instances of data storage resources may include file storage devices, block storage devices, and the like. Each type or configuration of an instance of a computing resource may be available in different sizes, such as large resources, consisting of many processors, large amounts of memory, and/or large storage capacity, and small resources consisting of fewer processors, smaller amounts of memory, and/or smaller storage capacity.

The instances of computing resources provided by the distributed execution environment 102 are enabled in one implementation by one or more data centers 704A-704N (which may be referred to herein singularly as “a data center 704” or collectively as “the data centers 704”). The data centers 704 are facilities utilized to house and operate computer systems and associated components. The data centers 704 typically include redundant and backup power, communications, cooling, and security systems. The data centers 704 might also be located in geographically disparate locations. One illustrative configuration for a data center 704 that implements some or all of the concepts and technologies disclosed herein for annotating resources in the distributed execution environment 102 will be described below with regard to FIG. 8.

The users 112 of the distributed execution environment 102 may access the computing resources provided by the data centers 704 over a suitable data communications network, such as a Wide Area Network (“WAN”) 702. Although a WAN 702 is illustrated in FIG. 7, it should be appreciated that a local-area network (“LAN”), the Internet, or any other networking topology known in the art that connects the data centers 704 to the user computing system 114 may be utilized. It should also be appreciated that combinations of such networks might also be utilized.

FIG. 8 is a computing system diagram that illustrates one configuration for a data center 704 that implements aspects of a distributed execution environment 102, including some or all of the concepts and technologies disclosed herein for annotating resources 104. The example data center 704 shown in FIG. 8 includes several server computers 802A-802F (which may be referred to herein singularly as “a server computer 802” or in the plural as “the server computers 802”) for providing instances of computing resources. The server computers 802 may be standard tower or rack-mount server computers configured appropriately for providing the computing resources described herein. For example, in one implementation the server computers 802 are configured to provide instances of computing resources 104A-104N.

In one embodiment, some of the instances of computing resources 104A are virtual machine instances. As known in the art, a virtual machine instance is an instance of a software implementation of a machine (i.e. a computer) that executes programs like a physical machine. Each of the servers 802 may be configured to execute an instance manager 808 capable of instantiating and managing instances of computing resources. In the case of virtual machine instances, for example, the instance manager 808 might be a hypervisor or another type of program configured to enable the execution of multiple virtual machine instances on a single server computer 802, for example.

It should be appreciated that although the embodiments disclosed herein are described primarily in the context of virtual machine instances, other types of instances of computing resources can be utilized with the concepts and technologies disclosed herein. For instance, the technologies disclosed herein might be utilized with instances of hardware resources, instances of data storage resources, instances of data communications resources, instances of networking resources, instances of database resources, and with other types of instances of computing resources.

The data center 704 shown in FIG. 8 also includes a server computer 802F reserved for executing software components for managing the operation of the data center 704, the server computers 802, the instances of computing resources 104, and other resources within the distributed execution environment 102. In particular, the server computer 802F might execute the resource monitoring component 106, the resource state viewing tool 108, and store one or more resource pages 110. Details regarding the operation of each of these components has been provided above. In this regard, it should be appreciated that while these components are illustrated as executing within the distributed execution environment 102, computing systems that are external to the distributed execution environment 102 might also be utilized to execute some or all of these components. Other configurations might also be utilized.

In the example data center 704 shown in FIG. 8, an appropriate local area network (“LAN”) 804 is utilized to interconnect the server computers 802A-802E and the server computer 802F. The LAN 804 is also connected to the WAN 702 illustrated in FIG. 7. It should be appreciated that the configuration and network topology illustrated in FIGS. 7 and 8 has been greatly simplified and that many more computing systems, networks, and networking devices may be utilized to interconnect the various computing systems disclosed herein. Appropriate load balancing devices or software modules might also be utilized for balancing a load between each of the data centers 704A-704N, between each of the server computers 802A-802F in each data center 704, and between instances of computing resources 104 provided by the distributed execution environment 102.

It should be appreciated that the data center 704 described in FIG. 8 is merely illustrative and that other implementations might also be utilized. In particular, functionality described herein as being performed by the resource monitoring component 106 and the resource state viewing tool 108 might be performed by one another, might be performed by other components, or might be performed by a combination of these or other components. Additionally, it should be appreciated that the functionality provided by these components might be implemented in software, hardware, or a combination of software and hardware. Other implementations should be apparent to those skilled in the art.

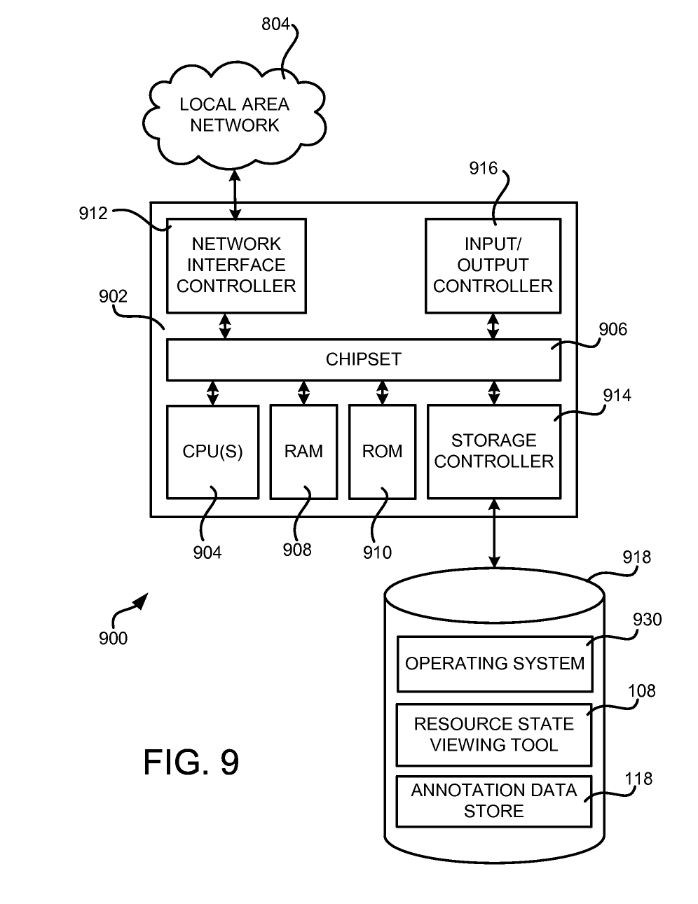

FIG. 9 shows an example computer architecture for a computer 900 capable of executing the program components described above for annotating resources 104 in a distributed execution environment 102. The computer architecture shown in FIG. 9 illustrates a conventional server computer, workstation, desktop computer, laptop, tablet, network appliance, personal digital assistant (“PDA”), e-reader, digital cellular phone, or other computing device, and may be utilized to execute any aspects of the software components presented herein described as executing on the user computing systems 114, within the data centers 704A-704N, on the server computers 802A-802F, or on any other computing system mentioned herein.

The computer 900 includes a baseboard 902, or “motherboard,” which is a printed circuit board to which a multitude of components or devices may be connected by way of a system bus or other electrical communication paths. In one illustrative embodiment, one or more central processing units (“CPUs”) 904 operate in conjunction with a chipset 906. The CPUs 904 may be standard programmable processors that perform arithmetic and logical operations necessary for the operation of the computer 900.

The CPUs 904 perform operations by transitioning from one discrete, physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, and the like.

The chipset 906 provides an interface between the CPUs 904 and the remainder of the components and devices on the baseboard 902. The chipset 906 may provide an interface to a random access memory (“RAM”) 908, used as the main memory in the computer 900. The chipset 906 may further provide an interface to a computer-readable storage medium such as a read-only memory (“ROM”) 910 or non-volatile RAM (“NVRAM”) for storing basic routines that help to startup the computer 900 and to transfer information between the various components and devices. The ROM 910 or NVRAM may also store other software components necessary for the operation of the computer 900 in accordance with the embodiments described herein.

The computer 900 may operate in a networked environment using logical connections to remote computing devices and computer systems through a network, such as the local area network 804. The chipset 906 may include functionality for providing network connectivity through a NIC 912, such as a gigabit Ethernet adapter. The NIC 912 is capable of connecting the computer 900 to other computing devices over the network 804. It should be appreciated that multiple NICs 912 may be present in the computer 900, connecting the computer to other types of networks and remote computer systems.

The computer 900 may be connected to a mass storage device 918 that provides non-volatile storage for the computer. The mass storage device 918 may store system programs, application programs, other program modules, and data, which have been described in greater detail herein. The mass storage device 918 may be connected to the computer 900 through a storage controller 914 connected to the chipset 906. The mass storage device 918 may consist of one or more physical storage units. The storage controller 914 may interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 900 may store data on the mass storage device 918 by transforming the physical state of the physical storage units to reflect the information being stored. The specific transformation of physical state may depend on various factors, in different implementations of this description. Examples of such factors may include, but are not limited to, the technology used to implement the physical storage units, whether the mass storage device 918 is characterized as primary or secondary storage, and the like.

For example, the computer 900 may store information to the mass storage device 918 by issuing instructions through the storage controller 914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 900 may further read information from the mass storage device 918 by detecting the physical states or characteristics of one or more particular locations within the physical storage units.

In addition to the mass storage device 918 described above, the computer 900 may have access to other computer-readable storage media to store and retrieve information, such as program modules, data structures, or other data. It should be appreciated by those skilled in the art that computer-readable storage media can be any available media that provides for the storage of non-transitory data and that may be accessed by the computer 900.

By way of example, and not limitation, computer-readable storage media may include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

The mass storage device 918 may store an operating system 930 utilized to control the operation of the computer 900. According to one embodiment, the operating system comprises the LINUX operating system. According to another embodiment, the operating system comprises the WINDOWS® SERVER operating system from MICROSOFT Corporation. According to further embodiments, the operating system may comprise the UNIX or SOLARIS operating systems. It should be appreciated that other operating systems may also be utilized. The mass storage device 918 may store other system or application programs and data utilized by the computer 900, such as the resource monitoring component 106, the resource state viewing tool 108, and/or any the other software components and data described above. The mass storage device 918 might also store other programs and data not specifically identified herein.

In one embodiment, the mass storage device 918 or other computer-readable storage media is encoded with computer-executable instructions which, when loaded into the computer 900, transforms the computer from a general-purpose computing system into a special-purpose computer capable of implementing the embodiments described herein. These computer-executable instructions transform the computer 900 by specifying how the CPUs 904 transition between states, as described above. According to one embodiment, the computer 900 has access to computer-readable storage media storing computer-executable instructions which, when executed by the computer 900, perform the various routines described above with regard to FIGS. 2, 3, 5, and 6.

The computer 900 may also include one or more input/output controllers 916 for receiving and processing input from a number of input devices, such as a keyboard, a mouse, a touchpad, a touch screen, an electronic stylus, or other type of input device. Similarly, the input/output controller 916 may provide output to a display, such as a computer monitor, a flat-panel display, a digital projector, a printer, a plotter, or other type of output device. It will be appreciated that the computer 900 may not include all of the components shown in FIG. 9, may include other components that are not explicitly shown in FIG. 9, or may utilize an architecture completely different than that shown in FIG. 9.

Based on the foregoing, it should be appreciated that technologies for annotating resources in a distributed execution environment have been presented herein. Moreover, although the subject matter presented herein has been described in language specific to computer structural features, methodological acts, and computer readable media, it is to be understood that the invention defined in the appended claims is not necessarily limited to the specific features, acts, or media described herein. Rather, the specific features, acts, and mediums are disclosed as example forms of implementing the claims.

The subject matter described above is provided by way of illustration only and should not be construed as limiting. Furthermore, the claimed subject matter is not limited to implementations that solve any or all disadvantages noted in any part of this disclosure. Various modifications and changes may be made to the subject matter described herein without following the example embodiments and applications illustrated and described, and without departing from the true spirit and scope of the present invention, which is set forth in the following claims.

What is claimed is:

1. A computer-implemented method for annotating a resource in a distributed execution environment, the method comprising performing computer-implemented operations for:
receiving a request to store an annotation associated with a resource in the distributed execution environment, the request comprising a resource identifier for the resource, the annotation, a namespace, and expiration data for the annotation;
storing the resource identifier, the annotation, the namespace, and the expiration data in response to receiving the request;
utilizing the expiration data to periodically expire stored annotations;
receiving a request for the annotations associated with a resource, the request comprising a resource identifier for the resource and a namespace; and
returning annotations in response to the request that have been associated with the resource identifier and that have an associated namespace that matches the namespace specified in the request.

2. The computer-implemented method of claim 1, wherein the expiration data comprises an expiration time, and wherein expiring stored annotations comprises expiring annotations when an associated expiration time has passed.

3. The computer-implemented method of claim 1, wherein the expiration data comprises an expiration event, and wherein expiring stored annotations comprises expiring annotations after the expiration event has occurred.

4. The computer-implemented method of claim 1, wherein expiring stored annotations comprises deleting the annotations or marking the annotations as having expired.

5. The computer-implemented method of claim 1, wherein each of the annotations further comprises one or more permissions identifying the rights of one or more users or components to read, modify, or delete the annotations.

6. The computer-implemented method of claim 1, wherein the resources comprise hardware resources utilized to provide instances of computing resources in the distributed execution environment.

7. The computer-implemented method of claim 1, wherein the resources comprise software resources.

8. The computer-implemented method of claim 1, wherein the resources comprise data describing users or customers of the distributed execution environment.

9. The computer-implemented method of claim 1, wherein the namespace is associated with a workflow.

10. The computer-implemented method of claim 1, wherein the namespace is associated with operational information for a resource.

11. A system for annotating resources in a distributed execution environment, the system comprising:
one or more computer systems executing a first component configured to
expose an interface through which annotations can be associated with resources in the distributed execution environment,
receive a request by way of the interface to store an annotation associated with a resource in the distributed execution environment, the request comprising a resource identifier for the resource, the annotation, and expiration data for the annotation, and
store the resource identifier, the annotation, and the expiration data in response to receiving the request; and
executing a second component configured to periodically expire stored annotations based upon the expiration data for the annotations.

12. The system of claim 11, wherein expiring stored annotations comprises marking the annotations as having expired.

13. The system of claim 11, wherein expiring stored annotations comprises deleting the annotations.

14. The system of claim 11, wherein the expiration data comprises an expiration time, and wherein expiring stored annotations comprises expiring annotations when an associated expiration time has passed.

15. The system of claim 11, wherein the expiration data comprises an expiration event, and wherein expiring stored annotations comprises expiring annotations after the expiration event has occurred.

16. The system of claim 11, wherein the request to store the resource further comprises a namespace associated with the annotation.

17. The system of claim 16, wherein the namespace is associated with a workflow.

18. The system of claim 16 wherein the namespace is associated with operational information for a resource.

19. A computer-readable storage medium having computer-executable instructions stored thereupon which, when executed by a computer, cause the computer to:
assign expiration data to an annotation associated with a resource in a distributed execution environment; and
utilize the assigned expiration data to expire the annotation.

20. The computer-readable storage medium of claim 19, wherein the expiration data comprises an expiration time for the annotation, and wherein expiring the annotation comprises deleting the annotation or marking the annotation as expired after the expiration time has passed.

21. The computer-readable storage medium of claim 19, wherein the expiration data comprises an expiration event for the annotation, and wherein expiring the annotation comprises deleting the annotation or marking the annotation as expired when the expiration event has occurred.

22. The computer-readable storage medium of claim 19, having further computer-executable instructions stored thereupon which, when executed by the computer, cause the computer to assign a namespace to the annotation and to utilize the namespace when responding to requests to retrieve the annotation.
